(19) United States
(12) Patent Application Publication
(10) Pub. No.: US 2010/0031541 A1
(43) Pub. Date: Feb. 11, 2010

(54) DOORBELL BLOCKING DEVICE

(76) Inventor: Kathleen J. Moyer, Rolesville, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/188,727

(22) Filed: Aug. 8, 2008

(51) Int. Cl. G09F 3/00

(52) U.S. Cl. 40/299.01

(57) ABSTRACT

A doorbell blocking device including a windowless faceplate for blocking access to a doorbell, a faceplate support structure including at least one support member defining a first surface for attaching the faceplate thereto, and a second surface for attachment to at least one of the doorbell and a doorframe, and a fastener for removeably attaching the faceplate to the first surface of the at least one support member and removeably attaching the second surface of the at least one support member to at least one of the doorbell and the doorframe. The device may include a plurality of distinct faceplates that may be interchanged to provide a customized message to a visitor of the home.

### FIELD OF THE INVENTION

The present invention relates generally to a device for preventing the interruption of a child's sleep, and more particularly, to a doorbell blocking device that is removeably and non-destructively attached to an existing doorbell to prevent the operation of the doorbell as desired.

### BACKGROUND OF THE INVENTION

Parents are continuously looking for ways to ensure that their children get an adequate amount of uninterrupted sleep. One solution to this problem includes the development of various devices designed to provide soothing music and sounds in order to drown out background noise. Other solutions include the development of devices designed to prevent interrupting sounds, thus providing a quiet environment. It is with regard to these second types of devices that this invention finds application.

Referring to prior art FIGS. 1A-B, one example of a conventional doorbell blocking device is shown generally at 10. The device includes a generally rectangular, hollow one-piece housing 11 defining a pair of openings 12 for receiving screws 13 (shown with covering caps) for permanently and destructively fastening the housing 11 to a doorframe. The housing 11 is sized such that it fits over and substantially encompasses an existing doorbell, such as a commonly installed about 3″×1″×1″ doorbell. The housing 11 further defines a window 14 for accessing a slidable cover panel 15. In operation, the cover panel 15 may be selectively raised or lowered to block/allow the operation of the underlying doorbell button. The cover panel 15 includes text thereon for alerting a visitor to the status of the desired operation of the doorbell. Specifically, the cover panel 15 is marked with the phrase “Please knock thank you” and is visible when the cover panel is in the lowered, blocking position. When the cover panel is in the raised position, the text is not visible, and the user is able to depress the doorbell button through the window 14.

This prior art design suffers several disadvantages. One disadvantage is that the device is fastened to the doorframe by a plurality of screws, and thus the installation/removal of the device requires the use of a tool and destruction to the underlying doorframe. Further, by using screws or other like permanent fasteners, the device is not intended to, and cannot be easily removed when not in use. Another disadvantage is that because the device and its components are permanently installed, the homeowner is not able to switch out housings to provide a customized blocking device. Another disadvantage is that the device permanently covers the existing doorbell when not in use, which may be undesirable for aesthetic reasons.

Referring to prior art FIG. 2, another example of a doorbell interruption device is shown generally at 20. In this prior art example, a conventional doorbell is entirely removed and replaced with doorbell 20. Doorbell 20 includes a housing 21, a doorbell button 22 and a bypass switch 23 for selectively bypassing the doorbell button 22. When the switch 23 is positioned in the “off” position, the doorbell is inoperable when depressed. When the switch 23 is in the “on” position, the doorbell is operable when depressed. The doorbell 20 further includes a visual indicator, such as a light, for alerting the visitor and homeowner to the position of the switch 23.

As in the previous prior art example, this example suffers several disadvantages as well. One disadvantage is that the installation of the doorbell requires the complete removal of the existing doorbell and installation of the new doorbell, which requires the use of tools and replacement with a doorbell that may not aesthetically match the home. Another disadvantage is that the doorbell button is not physically blocked, meaning that in the event of bypass switch failure, the doorbell may undesirably operate, waking a sleeping child.

Accordingly, what is desired is a doorbell blocking device for selectively, physically blocking access to an existing doorbell. Further, what is desired is a device that can be installed without the use of tools and is non-destructive to the existing doorbell and doorframe. Further, what is desired is a doorbell blocking device that may be customized with interchangeable faceplates without changing the underlying supportive structure.

### BRIEF SUMMARY OF THE INVENTION

It is an object of the invention to provide a device for preventing the interruption of a person's sleep.

It is another object of the invention to provide a device for physically blocking access to an operational doorbell button.

It is another object of the invention to provide a device including interchangeable, customized faceplates.

It is another object of the invention to provide device that is secured to an existing doorbell in a non-destructive manner by conventional fasteners.

It is another object of the invention to provide a device whose installation/removal does not require the use of tools.

It is another object of the invention to provide a doorbell blocking device that may be removed when not in use.

To achieve the foregoing and other objects and advantages, and in accordance with the purposes of the invention as embodied and broadly described herein, the present invention provides various embodiments of a doorbell-blocking device.

In one embodiment, the present invention provides a doorbell blocking device including first and second members that cooperatively support an interchangeable faceplate that may optionally including indicia thereon. Each of the respective first and second members are angled and define a portion for removable attachment to existing doorbell structure, and a portion for removeably attaching the faceplate thereto. The first and second members may include hook-and-loop fasteners for engaging complimentary hook-and-loop fasteners of the existing doorbell and the faceplate. In alternative embodiments, the hook-and-loop fasteners may be substituted for other non-destructive-type fasteners including, but not limited to, magnets. The faceplate is positioned on the first and second members in order to block access to a functioning doorbell button to prevent the operation of the doorbell as desired.

In another embodiment, the present invention provides a doorbell blocking device including a faceplate for preventing access to the underlying doorbell. The device is removably attached to the doorbell through a support structure in a non-destructive manner with conventional fasteners including, but not limited to, hook-and-loop fasteners, tape and magnets. The support structure may be attached to at least one side, the top or the bottom of the underlying doorbell. The support structure may be integral with the faceplate or may be removeably attached with the conventional fasteners.

In yet another embodiment, the present invention provides interchangeable, doorbell-blocking faceplates that are supported by structure non-destructively attached to an existing doorbell. Each of the interchangeable faceplates includes graphics thereon so that a homeowner can customize a message to a visitor of the home. For example, the faceplate may indicate whether a girl or boy is sleeping, and may include a message to please knock, a child is sleeping. The faceplates may further include any type of picture, graphic, colors, text or any other indicia. The graphics may be printed, engraved or include raised lettering. The faceplate and support structure may be made from any material including, but not limited to, plastic, metal, wood and like materials. In one embodiment, the faceplate may be made from a magnetic material or may include magnetic fasteners so that it can be placed at another location when not used at the doorbell, such as supported on a refrigerator.

In yet another embodiment, the present invention provides a doorbell-blocking device including a faceplate for preventing access to the underlying doorbell. The device is removeably attached to the underlying doorframe through a support structure in a non-destructive manner with conventional fasteners including, but not limited to, hook-and-loop fasteners, tape and magnets. The doorframe may include complimentary conventional fasteners for receiving the fasteners of the support structure. The support structure may include at least one C-shaped member defining a first surface for attachment against the backside of the faceplate, a second surface for attachment against the doorframe, and an interconnecting portion between the first and second surfaces. The support structure may be integral with the faceplate or may be removeably attached thereto.

### BRIEF DESCRIPTION OF THE DRAWINGS

These and other features, objects and advantages of the present invention are better understood when the following detailed description of the invention is read with reference to the accompanying drawings, in which:

FIGS. 1A-B are perspective views of a prior art doorbell blocking device that encompasses an existing doorbell;

FIG. 2 is a perspective view of a prior art doorbell-blocking device including a bypass switch;

FIG. 3 is an exploded perspective view of a doorbell-blocking device in accordance with an embodiment of the present invention;

FIG. 4 is a side perspective view of the device of FIG. 3 shown installed and with the faceplate removed;

FIG. 5 is a side perspective view of the device of FIG. 3 shown with the faceplate installed;

FIGS. 6A-B are front and back plan views, respectively, of an interchangeable faceplate including graphics thereon; and

FIG. 7 is a perspective view of an alternative embodiment of a doorbell blocking device including at least one C-shaped member shown with the faceplate removed.

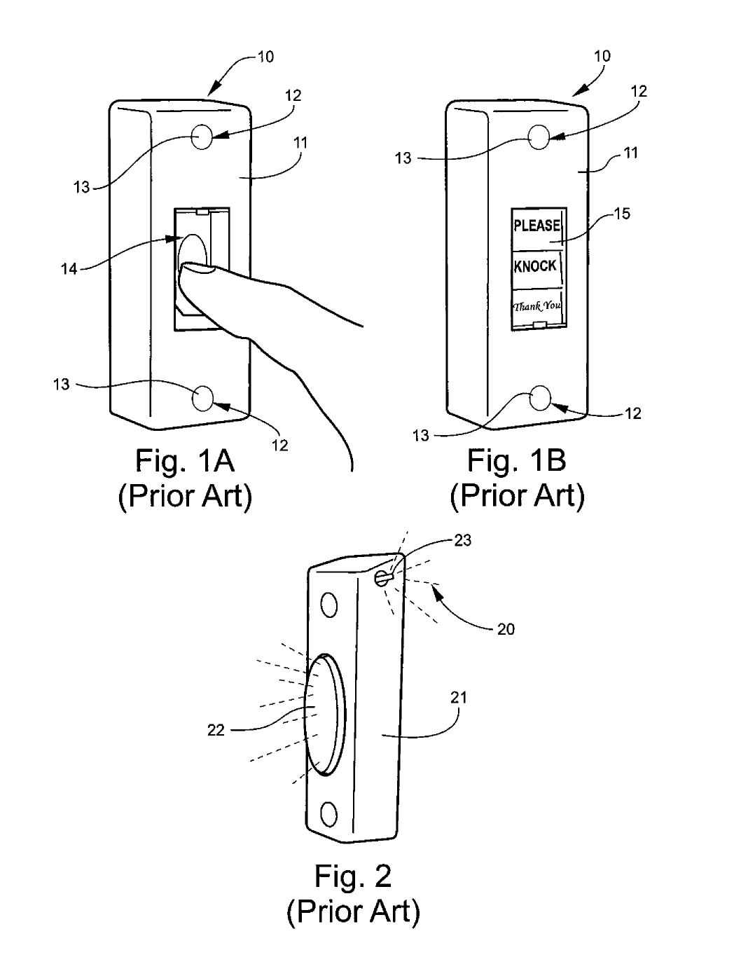

### DETAILED DESCRIPTION OF THE INVENTION

Referring now to the figures, preferred embodiments of doorbell blocking devices are provided for blocking access to an operational doorbell button. While the embodiment is described with reference to a standard about 3″×1″×1″ doorbell, the support structure may be modified by one skilled in the art to accommodate any existing doorbell size, shape and structure. Further, the support structure may be modified to include any number of components or the components may be made integral as known by one skilled in the art. The doorbell-blocking device may be made from any material including, but not limited to, plastic, metal, wood, like materials or combinations of materials.

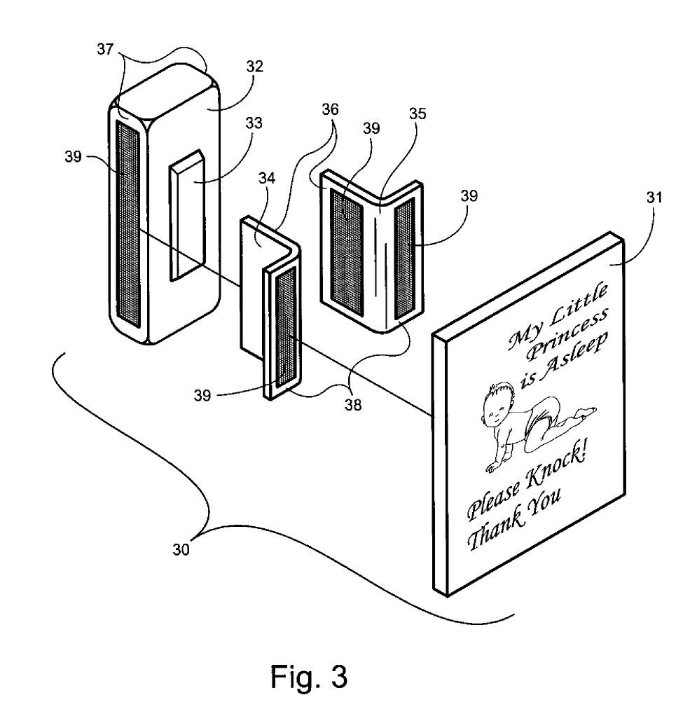

Referring to FIG. 3, a doorbell-blocking device 30 according to the present invention is shown in an exploded perspective view to illustrate each component. A detachable and interchangeable faceplate 31 is supported by an underlying support structure that attaches to the existing doorbell 32 including a doorbell button 33. The support structure includes first and second members 34, 35 that cooperatively provide a mounting surface for attaching the faceplate 31 thereto. The first and second members 34, 35 define an angle of about 90 degrees to provide a first surface 36 for mounting against the sides 37 of the doorbell 32, and a second surface 38 defining the faceplate-mounting surface. The support members 34, 35 are generally L-shaped. The doorbell button 33 is accessible through the support structure when the faceplate 31 is not installed.

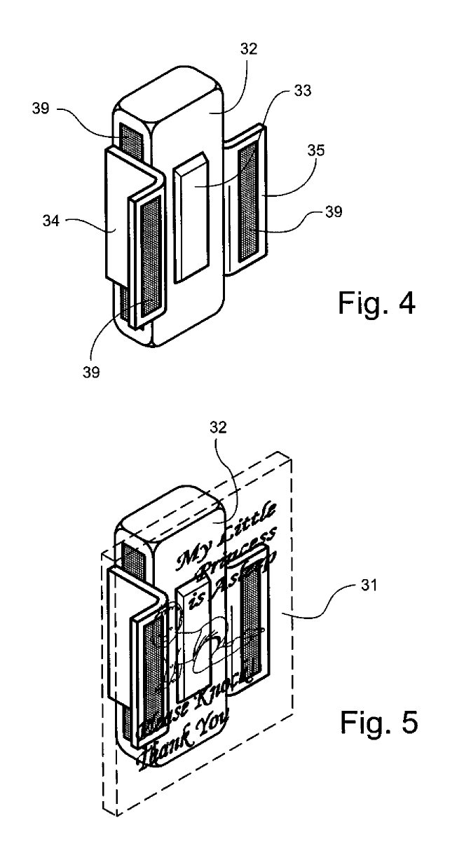

Referring to FIGS. 4 and 5, the doorbell-blocking device is shown partially and fully installed, respectively. The doorbell-blocking device is installed by first securing the first and second members 34, 35 to the doorbell 32, and then installing the faceplate 31 over the underlying first and second members. As shown, the doorbell 32, first and second members 34, 35, and faceplate 31 are preloaded with conventional fasteners 39. Suitable conventional fasteners of the present invention include, but are not limited to, non-destructive, releasable-type fasteners such as hook-and-loop fasteners, tapes and magnets. Specifically, a hook or loop fastener is applied to the doorbell 32, and the complimentary fastener is applied to the first surfaces 36 of the first and second members. A hook or loop fastener is applied to the backside of the faceplate 31 and a complimentary fastener is applied to the second surfaces 38 of the first and second members. The fasteners may cover all or a portion of their respective surfaces. In an exemplary embodiment, the backside of the faceplate may be substantially entirely covered with hook-and-loop or other fasteners to obviate exact placement on the underlying support structure surfaces. In an alternative embodiment, the faceplate 31 may be made from magnetic material or may include magnetic fasteners that compliment magnetic first and second members or magnetic strips. In the case of a faceplate that is all or partially magnetized, the faceplate may be stored on a refrigerator or other supporting surface when not in use.

Referring specifically to FIG. 5, the faceplate 31 is shown transparent to detail the underlying support structure. The faceplate is preferably sized so that the entire underlying doorbell 32 is covered and inaccessible. The faceplate is windowless and does not include a way to access the doorbell button through the faceplate when the faceplate is attached to the support structure. The faceplate 31 is preferably positioned at a distance from the doorbell button 33 so that the button cannot be accessed from above or beneath the faceplate. The faceplate 31 is preferably positioned at a great enough distance from the doorbell button 33 so that the backside of the faceplate does not depress the doorbell button if a visitor pushes the faceplate.

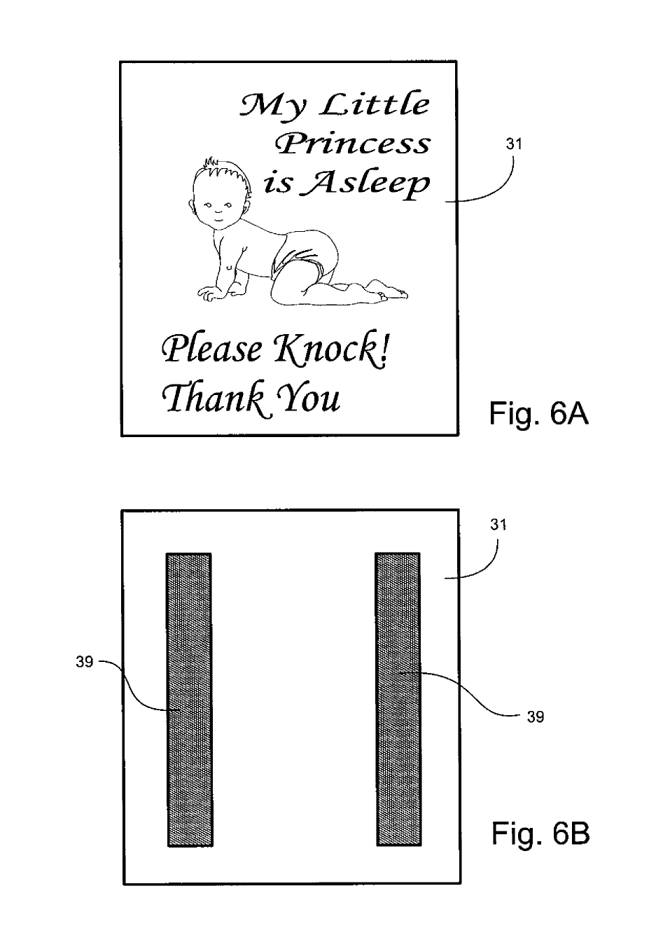

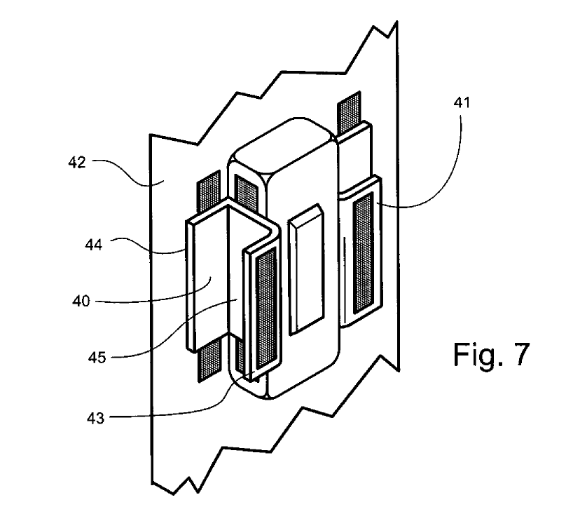

Referring to FIG. 6A, a front plan view of an exemplary faceplate 31 is shown. The faceplate has a generally rectangular shape but may have any desired shape. As stated above, the faceplate 31 is preferably dimensioned larger than the underlying doorbell. In an alternative embodiment, the faceplate 31 may be dimensioned equal to or smaller than the underlying doorbell. The faceplate 31 preferably includes graphics thereon, such as a message that a child is sleeping; please do not ring the bell. The faceplate 31 may be customized with text, pictures, artwork or colors as desired. The faceplate 31 may include printing, engraved lettering, recessed lettering or combinations thereof. In one embodiment, the faceplate 31 may be customized based on the sex of the child sleeping, and thus different faceplates may be sold to personalize the message. Various faceplates may be sold with the attached support structure as a kit of parts. Faceplates may also be sold individually. It is envisioned that blank faceplates may be sold and personalized by a homeowner.

Referring to FIG. 6B, a rear perspective view of the faceplate of FIG. 6A is shown. The faceplate includes conventional fasteners 39 that are preferably aligned with the complimentary fasteners of the support structure. The backside of the faceplate may further include recesses or raised alignment members for aligning the faceplate on the support structure. As stated above, the entire backside of the faceplate may be covered with conventional fasteners.

Referring to FIG. 7, an alternative embodiment of doorbell blocking support structure is shown. In this embodiment, the support structure includes first and second C-shaped support members 40, 41 for securing the faceplate the doorframe 42. The term “doorframe” as used herein is defined as any supporting structure to which the doorbell is mounted. Each of the first and second support members 40, 41 define a first portion 43 for attachment against the backside of the faceplate, and a second portion 44 for attachment against the doorframe 42, wherein the first and second surfaces are generally parallel. The C-shaped members 40, 41 further define an interconnecting portion 45 that may or may not attach to the underlying doorbell. This support structure embodiment may be used in applications in which it is not possible to attach the support structure to the doorbell due to the size and shape of the doorbell, or for when more support of the faceplate is desired. The support structure may be attached about the sides or the top and bottom of the doorbell as desired. Each portion of the C-shaped member 40, 41 may include a conventional fastener. In an exemplary embodiment, a single piece of hook-and-loop fastener, tape or like fastener may be applied across all attachment portions.

The doorbell-blocking device of the present invention is advantageous in that it does not require any tools for installation and does require disassembly or modification of the underlying doorbell as required by conventional devices.

The foregoing is a description of various embodiments of the invention that are given here by way of example only. Although examples have been described with reference to preferred embodiments thereof, other embodiments may perform similar functions and/or achieve similar results. Any and all such equivalent embodiments and examples are within the spirit and scope of the present invention and are intended to be covered by the appended claims.

What is claimed is:

1. A doorbell blocking device, comprising:
a windowless faceplate for blocking access to a doorbell;
a faceplate support structure including at least one support member defining a first surface for attaching the faceplate thereto, and a second surface for attachment to at least one of the doorbell and a doorframe; and
a fastener for removeably attaching the faceplate to the first surface of the at least one support member and removeably attaching the second surface of the at least one support member to at least one of the doorbell and the doorframe.

2. The doorbell blocking device according to claim 1, wherein the support structure comprises first and second support members that together cooperatively define a faceplate support surface.

3. The doorbell blocking device according to claim 1, wherein the at least one support member defines and an angle between the first and second surfaces.

4. The doorbell blocking device according to claim 1, wherein the first and second surfaces of the at least one support member are generally parallel.

5. The doorbell blocking device according to claim 1, wherein the at least one support member is generally L-shaped.

6. The doorbell blocking device according to claim 1, wherein the at least one support member is generally C-shaped.

7. The doorbell blocking device according to claim 1, wherein the fastener is selected from the group consisting of a hook-and-loop fastener, a tape, a magnet, and combinations thereof.

8. The doorbell blocking device according to claim 1, wherein the faceplate comprises at least one of graphics, text, colors, raised lettering, engraving, or other indicia on at least a front side of the faceplate.

9. The doorbell-blocking device according to claim 1, wherein a backside of the faceplate is at least partially covered with the fastener.

10. A doorbell blocking device, comprising:
a detachable faceplate for blocking access to an underlying doorbell;
faceplate support structure including at least one support member for attaching the faceplate to at least one of the underlying doorbell and a doorframe;
a first fastener for removeably fastening the detachable faceplate to the at least one support member; and
a second fastener for removeably fastening the at least one support member to at least one of the underlying doorbell and the doorframe.

11. The doorbell blocking device according to claim 10, wherein the first and second fasteners are selected from the group consisting of hook-and-loop fasteners, tape, magnets and combinations thereof.

12. The doorbell blocking device according to claim 10, wherein the faceplate support structure comprises first and second support members that together cooperatively define a mounting surface for the detachable faceplate.

13. The doorbell blocking device according to claim 10, wherein the at least one support member is generally L-shaped.

14. The doorbell blocking device according to claim 10, wherein the at least one support member is generally C-shaped.

15. The doorbell-blocking device according to claim 10, wherein the detachable faceplate has a front side surface area greater than that of the underlying doorbell.

16. The doorbell blocking device according to claim 10, wherein the detachable faceplate has a front side surface area equal to or less than that of the underlying doorbell.

17. The doorbell blocking device according to claim 10, wherein the detachable faceplate comprises at least one of graphics, text, colors, raised lettering, engraving, or other indicia on at least a front side of the faceplate.

18. The doorbell blocking device according to claim 10, further comprising a plurality of distinct interchangeable faceplates that may be installed as desired in order to present a customized message to a visitor of a home.
